(19) United States
(12) Patent Application Publication
(10) Pub. No.: US 2013/0267112 A1
(43) Pub. Date: Oct. 10, 2013

(54) POWER CONNECTOR ASSEMBLY AND ADAPTER PLUG WITH LOCKING MECHANISM

(71) Applicants: Atthapon Honghin, Amphur Muang (TH); Jui-Ching Huang, Amphur Muang (TH)

(72) Inventors: Atthapon Honghin, Amphur Muang (TH); Jui-Ching Huang, Amphur Muang (TH)

(73) Assignee: DELTA ELECTRONICS (THAILAND) PUBLIC CO., LTD., Amphur Muang (TH)

(21) Appl. No.: 13/441,602

(22) Filed: Apr. 6, 2012

(51) Int. Cl. H01R 4/50

(52) U.S. Cl. 439/346

(57) ABSTRACT

A power connector assembly includes an appliance plug and an adapter plug. The appliance plug has at two first contact terminals, wherein each of the first contact terminals has a perforation. The adapter plug includes a casing, a switching element, at least two second contact terminals, and at least two locking elements. Each of the locking elements has a protrusion part. When the switching element is located at a first position, the protrusion part of the locking element is accommodated within the perforation of the corresponding first contact terminal, so that the locking element is in a locked state. In the locked state, the first contact terminal and the corresponding locking element are coupled with each other and the first contact terminal and the corresponding second contact terminal are electrically connected with each other.

### FIELD OF THE INVENTION

The present invention relates to a power connector assembly, and more particularly to a power connector assembly with an appliance plug and an adapter plug. The present invention relates to an adapter plug with a locking mechanism.

### BACKGROUND OF THE INVENTION

With increasing development of science and technology, power converters such as power adapters or chargers become indispensable electronic appliances for many kinds of electrical apparatuses. For example, by means of the power adapters, the utility power may be rectified and then converted into DC power for supplying power-receiving devices such as notebook computers. Alternatively, by means of the chargers, the converted DC power may charge the rechargeable batteries of the power-receiving devices such as mobile phones or digital cameras.

Generally, the power converter includes a plug for plugging into a power socket to receive utility power. Since the international business is well developed and the leisure life quality is much valued nowadays, people frequently go abroad for business or travel. When people go abroad, they usually carry the portable electronic products such as notebooks, mobile phones and digital cameras. However, since there are various kinds of socket standards in the world, the power converter is usually connected with an adapter plug having different forms of contact terminals in order to comply with different socket standards.

FIG. 1 is a schematic exploded view illustrating a conventional power connector assembly. As shown in FIG. 1, the conventional power connector assembly 1 comprises an appliance plug 11 and an adapter plug 10. For example, the appliance plug 11 is a two-pin flat plug complying with US regulations and Taiwan regulations. That is, the appliance plug 11 has two flat contact terminals 111, which are parallel with each other. In a case that an electronic appliance with the two-pin flat appliance plug 11 is carried by the user for travel, the adapter plug 10 should be also carried in order to comply with the socket standards of the travelled countries or regions. For example, after the appliance plug 11 and the adapter plug 10 are combined together, the two cylindrical contact terminals 102 of the adapter plug 10 are suitably to be inserted into a corresponding socket of the specified countries or regions.

In the conventional power connector assembly 1, the two flat contact terminals 111 of the appliance plug 11 are inserted into the insertion holes 101 of the adapter plug 10. Consequently, the two flat contact terminals 111 are respectively and electrically connected with first ends of the two cylindrical contact terminals 102 of the adapter plug 10. In such way, the two flat contact terminals 111 of the appliance plug 11 are buried within the adapter plug 10, but the two cylindrical contact terminals 102 of the adapter plug 10 are exposed to be plugged into a corresponding socket (not shown). Although the conventional power connector assembly 1 is effective to change the plug type, there are still some drawbacks. For example, since there is no mechanism for securely combining the appliance plug 11 and the adapter plug 10 together, if a power cable 110 of the electronic appliance is accidently pulled by the user, the appliance plug 11 is possibly detached from the adapter plug 10. Under this circumstance, the power connection is possibly interrupted.

For solving the above drawbacks, another power connector assembly with engaging structures was disclosed. That is, the casing of the appliance plug and the casing of the adapter plug may be equipped with complementary engaging structures. Since the configurations of the appliance plug and the adapter plug become complicated, new molding tools are required to produce the appliance plug and the adapter plug. In other words, the process of fabricating the appliance plug and the adapter plug is time-consuming and the fabricating cost is increased. Moreover, the engaging structures of the appliance plug and the adapter plug are only able to securely combine the appliance plug and the adapter plug together. In a case that the user travels abroad, the appliance plug and the adapter plug have the engaging structures should be simultaneously carried. In other words, the process of carrying the specially designed appliance plug and the specially designed adapter plug is troublesome to the user.

### SUMMARY OF THE INVENTION

The present invention provides a power connector assembly comprising an appliance plug and an adapter plug with a locking mechanism, thereby securely combining the appliance plug with the adapter plug and electrically connecting the contact terminals of the appliance plug and the adapter plug.

The present invention also provides an adapter plug with a locking mechanism. Due to the locking mechanism of the adapter plug, the appliance plug can be changed to the adapter plug complying with the socket standards of the travelled countries or regions without the need of installing the engaging structures on the casings of the appliance plug and the adapter plug. Consequently, the fabricating cost is reduced and the applications are widened.

In accordance with an aspect of the present invention, there is provided a power connector assembly. The power connector assembly includes an appliance plug and an adapter plug. The appliance plug has at least two first contact terminals, wherein each of the first contact terminals has a perforation. The adapter plug includes a casing, a switching element, at least two second contact terminals, and at least two locking elements. The switching element is partially exposed outside the casing. The second contact terminals are disposed within the casing. The locking elements are disposed within the casing, wherein each of the locking elements has a protrusion part. When the switching element is located at a first position, the protrusion part of the locking element is accommodated within the perforation of the corresponding first contact terminal, so that the locking element is in a locked state. In the locked state, the first contact terminal and the corresponding locking element are coupled with each other and the first contact terminal and the corresponding second contact terminal are electrically connected with each other.

In accordance with another aspect of the present invention, there is provided an adapter plug to be connected with an appliance plug. The appliance plug has at least two first contact terminals. Each of the first contact terminals has a perforation. The adapter plug includes a casing, at least two second contact terminals, and a locking mechanism. The second contact terminals are disposed within the casing. The locking mechanism includes a switching element, a guiding plate, and at least two locking elements. The switching element is partially exposed outside the casing. The guiding plate is disposed within the casing and connected with the switching element. The locking elements are disposed within the casing, wherein each of the locking elements has a protrusion part. When the switching element is located at a first position, the protrusion part of the locking element is accommodated within the perforation of the corresponding first contact terminal, so that the locking element is in a locked state. In the locked state, the first contact terminal and the corresponding locking element are coupled with each other and the first contact terminal and the corresponding second contact terminal are electrically connected with each other.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional power connector assembly;

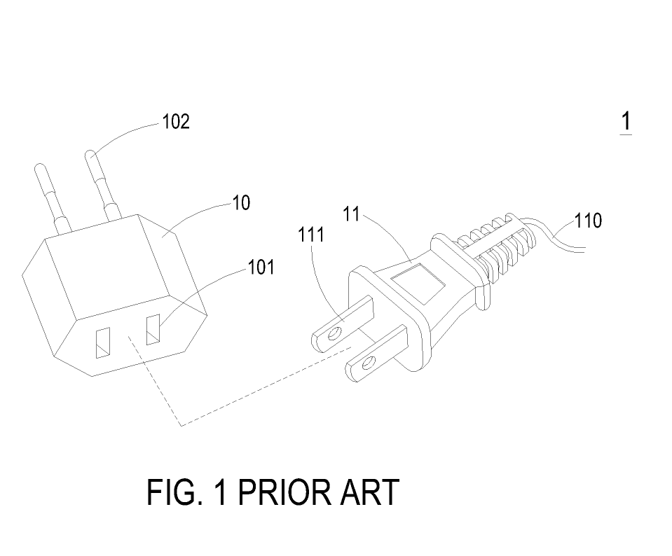

FIG. 2A is a schematic exploded view illustrating a power connector assembly according to an embodiment of the present invention;

FIG. 2B is a schematic assembled view illustrating the power connector assembly of FIG. 2A, in which the locking mechanism is in the locked state;

FIG. 2C is a schematic assembled view illustrating the power connector assembly of FIG. 2A, in which the locking mechanism is in the unlocked state;

FIG. 3A is a schematic cross-sectional illustrating the power connector assembly in the locked state; and

FIG. 3B is a schematic cross-sectional illustrating the power connector assembly in the unlocked state.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

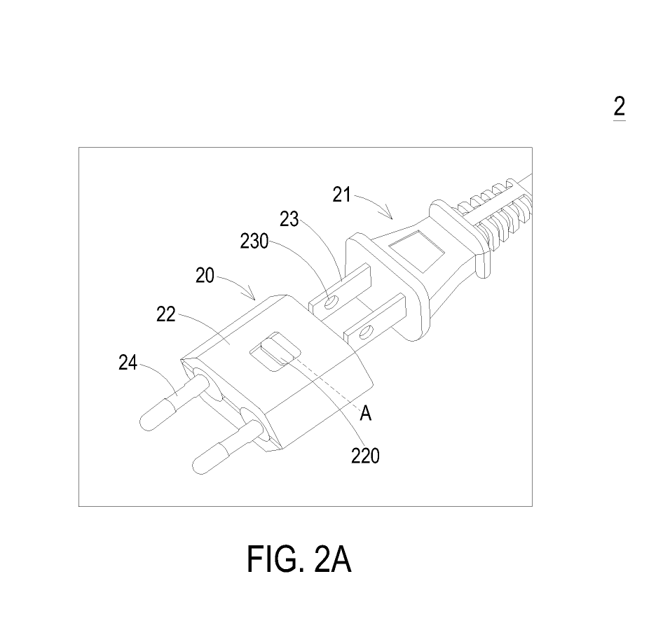

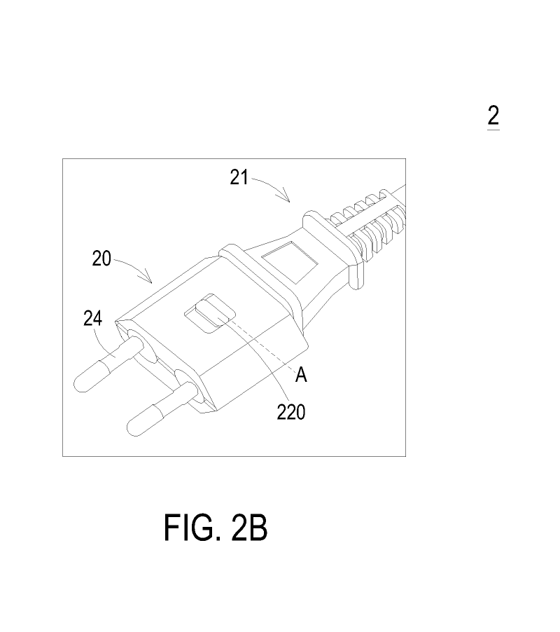

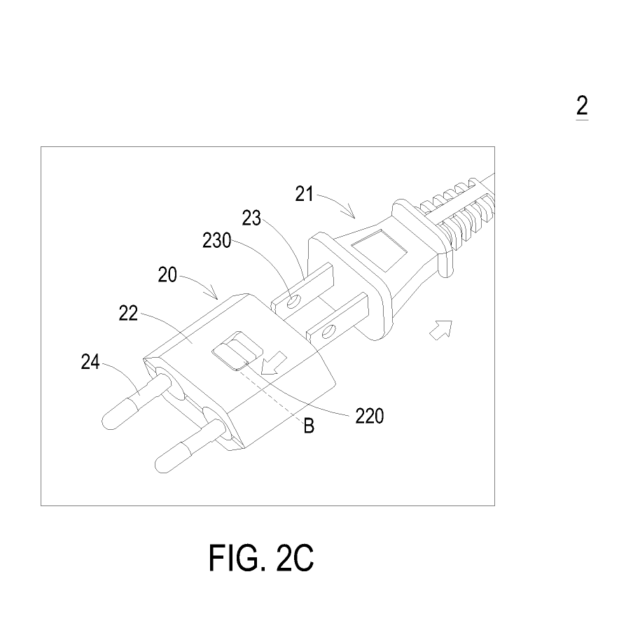

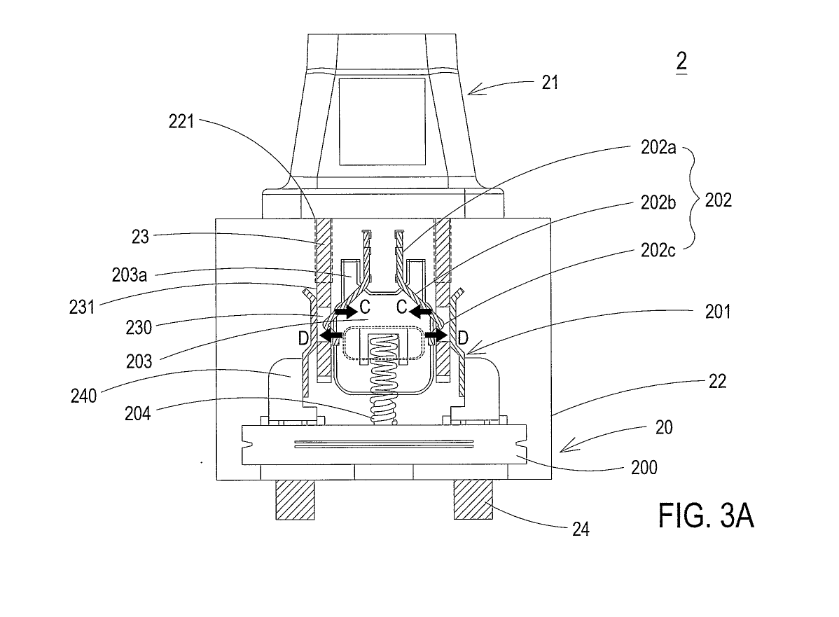

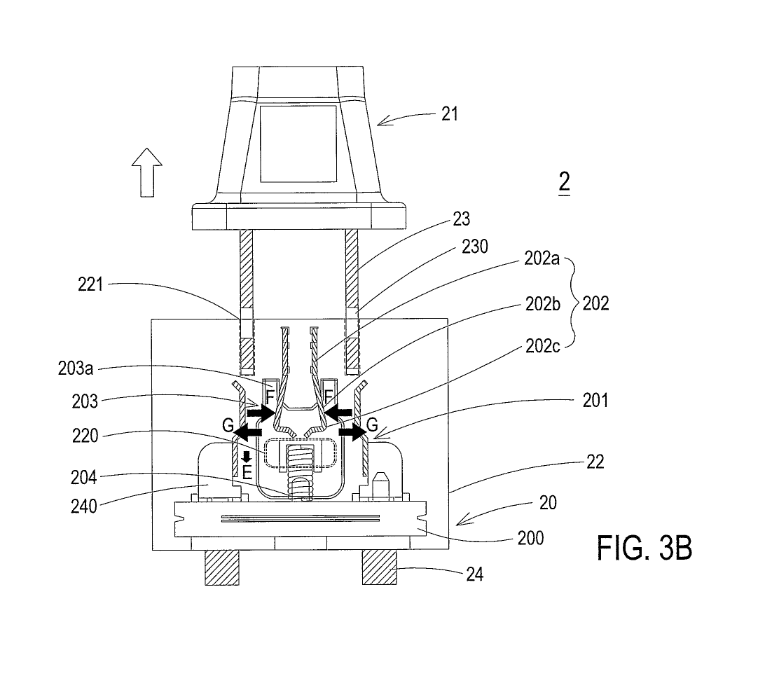

FIG. 2A is a schematic exploded view illustrating a power connector assembly according to an embodiment of the present invention. As shown in FIG. 2A, the power connector assembly 2 comprises an appliance plug 21 and an adapter plug 20. The appliance plug 21 has at least two first contact terminals 23. For example, the appliance plug 21 is a two-pin flat plug complying with US regulations and Taiwan regulations. That is, the appliance plug 21 has two flat contact terminals 23 (i.e. the first contact terminals), which are parallel with each other. In addition, each of the first contact terminals 23 has a perforation 230 at the front end thereof. The adapter plug 20 has a casing 22. A switching element 220 is partially exposed outside a top surface of the casing 22. In response to a pushing force exerted on the switching element 220 by the user, a locking mechanism is switched between a locked state and an unlocked state. In accordance with the present invention, the locking mechanism comprises the switching element 220, two locking elements 202 and a guiding plate 203, which will be illustrated later (see FIGS. 3A and 3B). In addition, a first side of the casing 22 further comprises two insertion holes 221 corresponding to the first contact terminals 23 of the appliance plug 21 (see FIG. 3A). Consequently, the first contact terminals 23 may be inserted into the insertion holes 221 of the casing 22. Moreover, two third contact terminals 24 are protruded from a second side of the casing 22, wherein the first side is opposed to the second side. The profiles of the third contact terminals 24 are determined according to the socket standards of different countries or regions. In this embodiment, the two third contact terminals 24 are two cylindrical contact terminals complying with European socket standards.

Please refer to FIG. 2A again. In a case that the appliance plug 21 is separated from the adapter plug 20, the switching element 220 is normally located at the first position A. Under this circumstance, the locking mechanism is in the locked state.

FIG. 2B is a schematic assembled view illustrating the power connector assembly of FIG. 2A, in which the locking mechanism is in the locked state. After the first contact terminals 23 of the appliance plug 21 are inserted into the insertion holes 221 of the adapter plug 20, the appliance plug 21 and the adapter plug 20 are combined as the power connector assembly 2. In such way, the two-pin flat plug complying with US regulations and Taiwan regulations is changed to two cylindrical-pin plug complying with European regulations. Please refer to FIG. 2B again. After the appliance plug 21 and the adapter plug 20 are combined as the power connector assembly 2, the switching element 220 is still located at the first position A. Meanwhile, the locking mechanism is maintained in the locked state. Since the appliance plug 21 is securely combined with the adapter plug 20, the possibility of loosening the appliance plug 21 in response to the external force will be minimized.

FIG. 2C is a schematic assembled view illustrating the power connector assembly of FIG. 2A, in which the locking mechanism is in the unlocked state. For detaching the appliance plug 21 from the adapter plug 20, the user may simply apply a pushing force to move the switching element 220 to a second position B, so that the locking mechanism is in an unlocked state. Meanwhile, the appliance plug 21 is removable from the adapter plug 20 without difficulty. After the pushing force exerted on the switching element 220 is eliminated, the switching element 220 will be returned to the first position A in response to elasticity of elastic element 204 (see FIG. 3B), which will be illustrated later. Consequently, the locking mechanism is returned to the locked state.

Hereinafter, the operations of the switching element 220 will be illustrated with reference to FIGS. 3A and 3B. FIG. 3A is a schematic cross-sectional illustrating the power connector assembly in the locked state. FIG. 3B is a schematic cross-sectional illustrating the power connector assembly in the unlocked state. As shown in FIG. 3A, the adapter plug 20 further comprises two second contact terminals 201 and two locking elements 202. The two second contact terminals 201 and the two locking elements 202 are disposed within the casing 22 of the adapter plug 20. A first end of the second contact terminal 201 is electrically connected with an inner part 240 of a corresponding third contact terminal 24. A second end of the second contact terminal 201 is a free end.

In this embodiment, the locking element 202 comprises a main body 202a and a resilient arm 202b. In addition, a protrusion part 202c is located at a bending zone of the resilient arm 202b. Moreover, depending on the position of the switching element 220, the resilient arms 202b are shifted outwardly or inwardly (as shown in the direction of arrow), so that the protrusion part 202c of the resilient arm 202b is accommodated within or detached from the perforation 230 of the first contact terminal 23. In such way, the locking mechanism is alternatively in the locked state or the unlocked state.

Moreover, the adapter plug 20 further comprises a base 200. The third contact terminals 24 are penetrated through the base 200. Consequently, the inner parts 240 of the third contact terminals 24 are disposed and supported on the base 200.

In this embodiment, the adapter plug 20 further comprises a guiding plate 203 and an elastic element 204. The guiding plate 203 and the elastic element 204 are disposed within the casing 22 of the adapter plug 20. The guiding plate 203 is connected with the switching element 220. In addition, the guiding plate 203 has two rib parts 203a. The locations of the two locking elements 202 correspond to bilateral sides of the guiding plate 203. The resilient arm 202b is arranged beside a corresponding rib part 203a of the guiding plate 203. A first end of the elastic element 204 is fixed on the base 200. A second end of the elastic element 204 is fixed on the guiding plate 203. Consequently, during the process of moving the switching element 220 toward the second position B, the elastic element 204 is compressed in response to a pushing force exerted on the switching element 220. After the external force exerted on the switching element 220 is eliminated, elasticity of the elastic element 204 causes the guiding plate 203 to be moved toward the first position A, and thus the switching element 220 is returned to the first position A.

Please refer to FIG. 3A again. The process of inserting the first contact terminals 23 of the appliance plug 21 into the insertion holes 221 of the adapter plug 20 will be illustrated as follows. Firstly, the front end of the first contact terminal 23 is in contact with the protrusion part 202c of the corresponding locking element 202, so that the resilient arm 202b of the locking element 202 is shifted inwardly (as shown in the direction of arrow C). Then, as the first contact terminal 23 is continuously and downwardly moved, the perforation 230 of the first contact terminal 23 will be aligned with the protrusion part 202c of the locking element 202. Consequently, the resilient arm 202b of the locking element 202 is shifted outwardly (as shown in the direction of arrow D), and the protrusion part 202c of the locking element 202 is accommodated within the perforation 230 of the first contact terminal 23. Under this circumstance, the locking element 202 is in the locked state, and the appliance plug 21 and the adapter plug 20 are securely combined together. At the same time, the outer surface 231 of the first contact terminal 23 of the appliance plug 21 is in contact with the corresponding second contact terminal 201, so that the appliance plug 21 and the adapter plug 20 are electrically connected with each other.

Please refer to FIG. 3B again. For the process of separating the appliance plug 21 from the adapter plug 20, the user may move the switching element 220 toward the second position B. As the switching element 220 is moved toward the second position B, the guiding plate 203 is also moved downwardly (as shown in direction of the arrow E), and thus the elastic element 204 is further compressed. Until the guiding plate 203 is moved to the second position B, the resilient arm 202b of the locking element 202 is pushed by the inner surface of a corresponding rib part 203a of the guiding plate 203, so that the resilient arm 202b of the locking element 202 is shifted inwardly (as shown in the direction of arrow F). Then, the protrusion part 202c of the locking element 202 is detached from the perforation 230 of the first contact terminal 23. Consequently, the locking element 202 is in the unlocked state, and the appliance plug 21 is removable from the adapter plug 20. After the pushing force exerted on the switching element 220 is eliminated, the switching element 220 will be returned to the first position A in response to elasticity of the elastic element 204. Consequently, the locking element 202 is returned to the locked state. Moreover, since the resilient arm 202b is no longer pushed by the inner surface of the corresponding rib part 203a of the guiding plate 203, the resilient arm 202b is shifted outwardly again (as shown in the direction of arrow G) due to the elasticity of the resilient arm 202b (see FIG. 3A).

From the above description, the power connector assembly comprises an appliance plug and an adapter plug with a locking mechanism. The switching element, the two locking elements and the guiding plate are collectively defined as the locking mechanism. When the first contact terminals of the appliance plug are inserted into the insertion holes of the adapter plug, the protrusion parts of the locking elements are accommodated within corresponding perforations of the first contact terminals. Consequently, the first contact terminals of the appliance plug are securely coupled with corresponding locking elements. Under this circumstance, the locking mechanism is in a locked state, and the first contact terminals of the appliance plug are electrically connected with corresponding second contact terminals of the adapter plug. Moreover, for allowing the locking mechanism to be in the unlocked state, the user may move the switching element to shift the locking element shift inwardly. Consequently, the first contact terminals are detached from the locking elements. Meanwhile, the appliance plug can be easily removed from the adapter plug.

Moreover, due to the locking mechanism of the adapter plug, the appliance plug can be changed to the adapter plug with desired contact terminals complying with the socket standards of the travelled countries or regions without the need of installing the engaging structures on the casings of the appliance plug and the adapter plug. Consequently, the fabricating cost is reduced and the applications are widened. Moreover, since the locking mechanism is normally in the locked state after the appliance plug is inserted into the adapter plug, the appliance plug and the adapter plug are securely combined together. Consequently, even if power cable of the electronic appliance is accidently pulled by the user, the possibility of detaching the appliance plug and the possibility of causing power interruption will be minimized, and the supplied power is more stable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power connector assembly, comprising:
an appliance plug having at least two first contact terminals, wherein each of said first contact terminals has a perforation; and
an adapter plug comprising:
a casing;
a switching element partially exposed outside said casing;
at least two second contact terminals disposed within said casing; and
at least two locking elements disposed within said casing, wherein each of said locking elements has a protrusion part,
wherein when said switching element is located at a first position, said protrusion part of said locking element is accommodated within said perforation of said corresponding first contact terminal, so that said locking element is in a locked state, and wherein in said locked state, said first contact terminal and said corresponding locking element are coupled with each other and said first contact terminal and said corresponding second contact terminal are electrically connected with each other.

2. The power connector assembly according to claim 1, wherein when said switching element is located at a second position, said protrusion part of said locking element is detached from said perforation of said first contact terminal, so that said locking element is in an unlocked state and said appliance plug is removable from said adapter plug.

3. The power connector assembly according to claim 2, wherein said adapter plug further comprises at least two third contact terminals, wherein a first end of each third contact terminal is protruded outside of said casing, and a second end of each third contact terminal is electrically connected with a corresponding second contact terminal.

4. The power connector assembly according to claim 3, wherein said first contact terminals are flat contact terminals, and said third contact terminals are cylindrical contact terminals.

5. The power connector assembly according to claim 2, wherein said adapter plug further comprises a guiding plate, which are disposed within said casing and connected with said switching element, wherein said guiding plate further comprises at least two rib parts.

6. The power connector assembly according to claim 5, wherein said adapter plug further comprises an elastic element and a base, wherein said elastic element is disposed within said casing, a first end of said elastic element is fixed on said base, and a second end of said elastic element is fixed on said guiding plate, wherein during said switching element is moved from said first position to said second position in response to a pushing force, said elastic element is compressed, wherein after said pushing force is eliminated, said elastic element is restored to an original status, so that said switching element is returned to said first position.

7. The power connector assembly according to claim 5, wherein each of said locking elements comprises a resilient arm, said protrusion part is arranged on said resilient arm, and said resilient arm is located beside said corresponding rib part of said guiding plate, wherein during said switching element is moved from said first position to said second position, said resilient arm is pushed by an inner surface of said corresponding rib part, so that said protrusion part of said locking element is detached from said perforation of said first contact terminal.

8. An adapter plug to be connected with an appliance plug, said appliance plug having at least two first contact terminals, each of said first contact terminals having a perforation, said adapter plug comprising:
a casing;
at least two second contact terminals disposed within said casing; and
a locking mechanism comprising:
a switching element exposed outside said casing;
a guiding plate disposed within said casing and connected with said switching element; and
at least two locking elements disposed within said casing, wherein each of said locking elements has a protrusion part,
wherein when said switching element is located at a first position, said protrusion part of said locking element is accommodated within said perforation of said corresponding first contact terminal, so that said locking element is in a locked state, wherein in said locked state, said first contact terminal and said corresponding locking element are coupled with each other and said first contact terminal and said corresponding second contact terminal are electrically connected with each other.

9. The adapter plug according to claim 8, wherein when said switching element is located at a second position, said protrusion part of said locking element is detached from said perforation of said first contact terminal, so that said locking element is in an unlocked state and said appliance plug is removable from said adapter plug.

10. The adapter plug according to claim 9, further comprising:
at least two third contact terminals, wherein a first end of each third contact terminal is protruded outside of said casing, and a second end of each third contact terminal is electrically connected with a corresponding second contact terminal;
a base; and
an elastic element disposed within said casing, wherein a first end of said elastic element is fixed on said base, and a second end of said elastic element is fixed on said guiding plate wherein during said switching element is moved from said first position to said second position in response to a pushing force, said elastic element is compressed, wherein after said external force is eliminated, said elastic element is restored to an original status, so that said switching element is returned to said first position.

11. The adapter plug according to claim 10, wherein said guiding plate further comprises at least two rib parts, each of said locking elements comprises a resilient arm, said protrusion part is arranged on said resilient arm, and said resilient arm is located beside said corresponding rib part of said guiding plate, wherein during said switching element is moved from said first position to said second position, said resilient arm is pushed by an inner surface of said corresponding rib part, so that said protrusion part of said locking element is detached from said perforation of said first contact terminal.
